(19) United States
(12) Patent Application Publication
(10) Pub. No.: US 2022/0089233 A1
(43) Pub. Date: Mar. 24, 2022

(54) ENDLESS TRACK FOR A TRACK LAYING VEHICLE HAVING A SHOE ASSEMBLY WITH A COMPOSITE TRACK SHOE

(71) Applicant: General Dynamics Land Systems, Sterling Heights, MI (US)

(72) Inventor: Michael B. Bamford, Sterling Heights, MI (US)

(73) Assignee: General Dynamics Land Systems, Sterling Heights, MI (US)

(21) Appl. No.: 16/948,594

(22) Filed: Sep. 24, 2020

(51) Int. Cl. B62D 55/21; B62D 55/28; B62D 55/20

(52) U.S. Cl. CPC B62D 55/21; B62D 55/06; B62D 55/202; B62D 55/28

(57) ABSTRACT

A composite track shoe and an endless track suitable for a tracked vehicle is described herein. The composite track shoes has a shoe body with a first bearing block extending from a first lateral edge and a second bearing block extending from a second lateral edge. The shoe body also has a center guide extending from a first face thereof the shoe body. A track pad is detachably secured to the track shoe and extends from a second face of the shoe body opposite the first face. An endless track is formed by interlinking the first bearing block on a first track shoe with the second bearing block a second track shoe positioned adjacent to the first track shoe. A pin extends through the first bearing block of the first track shoe and the second bearing block of the second track shoe for pivotally coupling them together.

### FIELD

The present disclosure relates to an endless track for a track laying vehicle and more particularly to a composite shoe assembly for an endless track.

### BACKGROUND

This section provides background information related to the present disclosure which is not necessarily prior art.

Endless or continuous tracks have been used for years with vehicles such as tanks or other heavy equipment to facilitate off-the-road travel. A pair of such tracks are conventionally utilized in spaced relation on the lateral side of a chassis for such vehicles. An outwardly facing side of each track engages the ground while an inwardly facing side of the track engages a drive wheel coupled to a powertrain system. A set of roadwheels connected to the suspension system support the chassis and engage the inwardly facing side along a lower reach of the track. An idler wheel, and support rollers are located along an upper reach of the track above the road wheels.

The conventional construction of an endless track for a track laying vehicle includes a plurality of shoe assemblies which are interconnected along the length of the track. Typically each shoe assembly has a metal shoe housing on which an outwardly facing road pad and an inwardly facing roadwheel pad are mounted. While roadwheel pads do not normally wear significantly, road pads can wear relatively quickly, and therefore should be readily replaceable. Such replacement often require the removal of the endless track from the vehicle.

Conventional track shoes are connected by a coupler that extends through the housings of two adjacent shoes. The coupler includes an outer sleeve located within the housings of the two shoes, a pin that extends through the outer sleeve and rubber bushings that is interposed between the pin and the sleeve portions. Hollow pins have been utilized with vehicle tracks to reduce the track weight. However, such hollow pins reduce the strength of the ends of the pins where end connectors are secured to provide connection between adjacent shoe assemblies, of a double pin track assembly, and, as such, present a strength problem.

To provide guiding of vehicle tracks, each shoe assembly of conventional tracks includes a spur that extends in an inward direction and is received within a center slot of the road wheels. In the case of a double pin track; the spur is clamped onto central portions of the pin between adjacent shoe assemblies. Adjacent shoe assemblies are connected by end connectors that extend between the adjacent pin ends and cooperate with the spur for securing the shoe assemblies to each other. In particular, between the opposite pin ends, adjacent track shoes of vehicle tracks are connected by the clamping the spur extending between intermediate portions of the adjacent pins at a location laterally between the shoes of the track. The dual function of guiding and connecting the adjacent pins results in a substantial loading during use.

Given the wear and tear experienced by the shoe assemblies of such tracked vehicles and the need for frequent repair and replacement of the components of these assemblies, there is a continuing effort in the art to develop shoe assemblies that are relatively light in weight, strong in design, durable in nature and easy to repair and replace.

### SUMMARY

This section provides a general summary of the disclosure and is not a comprehensive disclosure of its full scope or all of its features.

A shoe assembly suitable for an endless track on a tracked vehicle is described herein. The shoe assembly include a composite track shoe having a shoe body. A first bearing block extends from a first lateral edge of the shoe body and includes with a medial knuckle. A second bearing block extends from a second lateral edge of the shoe body opposite the first lateral edge and includes with a pair of lateral knuckles. A second bearing block recess is formed between the pair of lateral knuckles. The medial knuckle is configured to be received in the second bearing block recess of an adjacent track shoe. The composite track shoe also includes a center guide extending from a first face of the shoe body. A track pad is detachably secured to the track shoe and extends from a second face of the shoe body opposite the first face. A pin extends through the first bearing block and is further configured to extend through the second bearing block of the adjacent track shoe.

The shoe body, the first bearing block, the second bearing block and the center guide form a monolithic composite track shoe. In this context, the elements or features (e.g., shoe body, bearing blocks and center guide) of a monolithic track shoe are formed as a single, integral component. A monolithic composite track shoe of this configuration may be constructed for a polymeric material, for example a monolithic acetal copolymer.

An endless track suitable for a tracked vehicle is also described herein. The endless track includes a plurality of composite track shoes arranged in spaced adjacent relationship and operably coupled together. Each of the plurality of composite track shoes has a shoe body including a first bearing block with a medial knuckle extending from a first lateral edge of the shoe body, a second bearing block with a pair of lateral knuckles extending from a second lateral edge of the shoe body opposite the first lateral edge and a second bearing block recess formed there between. The shoe body also has a center guide extending from a first face thereof the shoe body. The medial knuckle on a first track shoe is received in the second bearing block recess between the pair of lateral knuckles of a second track shoe positioned adjacent to the first track shoe. A track pad is detachably secured to the track shoe and extends from a second face of the shoe body opposite the first face. A pin extends through the first bearing block of the first track shoe and the second bearing block of the adjacent track shoe for pivotally coupling the first and second track shoes together.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 illustrates a track laying vehicle with a pair of endless tracks, each track having a plurality of shoe assemblies;

FIG. 2 is an expanded view of a shoe assembly from the endless track shown in FIG. 1;

FIG. 3 is a top view of a composite track shoe from the shoe assembly shown in FIG. 2;

FIG. 4 is a cross-section of the composite track shoe taken at line 4-4 of FIG. 3;

FIG. 5 is a cross-section of the composite track shoe taken at line 5-5 of FIG. 3;

FIG. 6 is a cross-section of the composite track shoe taken at line 6-6 of FIG. 3;

FIG. 7 is a front view showing the shoe assembly with a schematic illustration of the road wheels; and

FIG. 8 is a cross section (similar to FIG. 6) showing a portion of the endless track with a schematic illustration of a sprocket wheel.

Corresponding reference numerals indicate corresponding parts throughout the several views of the drawings.

### DETAILED DESCRIPTION

Example embodiments will now be described more fully with reference to the accompanying drawings.

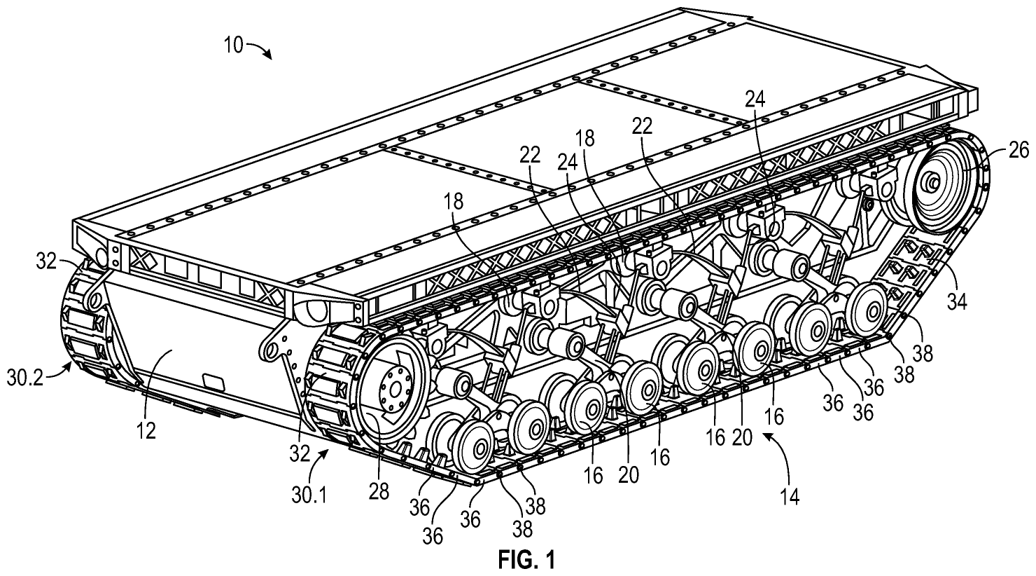

With reference not to FIG. 1, a track laying vehicle 10 includes a chassis 12 supporting a vehicle suspension assembly 14 disposed on each side of the chassis 12. While FIG. 1 only illustrates a left side vehicle suspension assembly, one skilled in the art will understand that a similar vehicle suspension assembly is provided on the right side of the chassis 12. Each vehicle suspension assembly 14 includes a plurality of road wheels 16 and support wheels 18 coupled to the chassis 12 by associated suspension links 20. Each vehicle suspension assembly 14 also includes, springs 22 and dampers 24. An idler wheel 26 is supported at the end of the chassis 12 opposite the drive wheel through a rotating support. A drive wheel 28 with a rotating support at one end of the chassis 12 and coupled to a powertrain (not shown). The chassis 12 illustrated in FIG. 1 shows a generic chassis platform. One skilled in the art should understand that the chassis 12 may be configured for a wide variety of track laying vehicles including various military vehicles such as tanks or other armored vehicles as well as various heavy equipment such as dozers, loaders, excavators, or shovels.

Endless tracks 30.1, 30.2 (collectively 30) are disposed on each side of the chassis 12 and supported on the suspension assembly 14. An outwardly facing side 32 of each track 30 engages the ground. An inwardly facing side 34 of the track 30 engages the road wheels 16, support wheels 18, idler wheel 26, and drive wheel 28. Each track 30 includes a plurality of shoe assemblies 36 pivotally connected a pin assembly 38. Some but not all of the shoe assemblies 36 and pin assemblies 38 are labelled in FIG. 1.

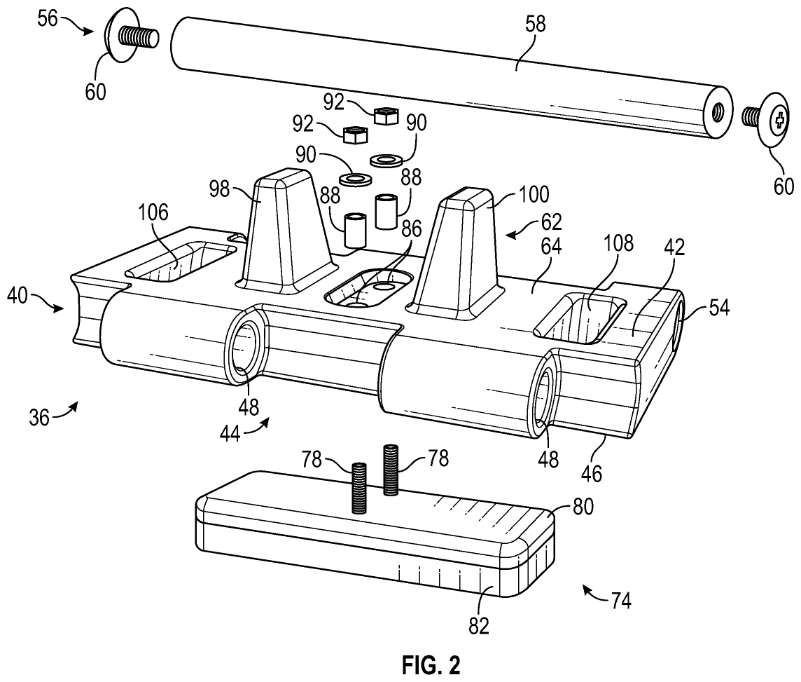

With reference now to FIGS. 2-6, each shoe assembly 36 includes a composite track shoe 40 having a shoe body 42. A first bearing block 44 extending from a first lateral edge 46 of the shoe body 42 and having a first bore 48 formed there through. A second bearing block 50 extends from a second lateral edge 52 of the shoe body 42 opposite the first lateral edge 46 and has a second bore 54 formed therethrough. The first bearing block 44 of a first track shoe 40.1 may be interlinked with the second bearing block 50 of a second track shoe 40.2 and pivotally coupled together by a pin assembly 56. The first and second bearing blocks 44, 50 are configured with complementary features such that that the first bearing block 44 of the first track shoe 40.1 interlinks with the second bearing block 50 of a second track shoe 40.2 adjacent the first track shoe 40.1. The pin assembly 56 includes a pin 58 inserted through the first and second bore 48, 54 for pivotally coupling adjacent track shoes 40.1, 40.2 together. Threaded fasteners 60 are received in and retain the pin 58 in the track shoe 40. A center guide 62 extends from a first face 64 of the shoe body 42.

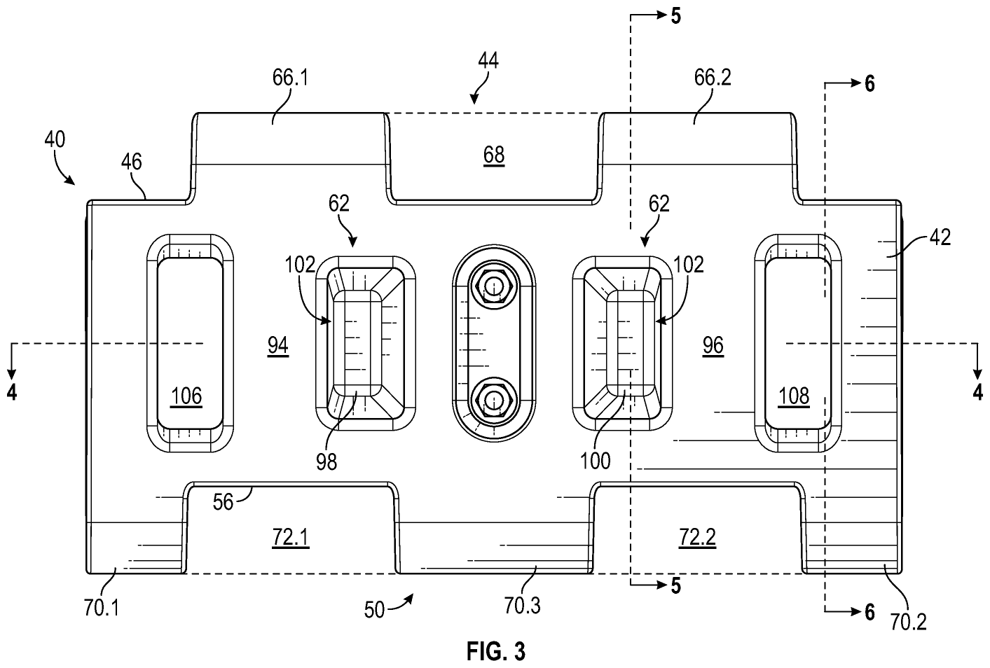

As best shown in FIG. 3, the first bearing block 44 includes first and second medial knuckle portions 66.1, 66.2 (collectively a medial knuckle 66) extending from the first lateral edge 46 of the shoe body 42. A first bearing block recess 68 is formed between first and second medial knuckle portions 66.1, 66.2. The second bearing block 50 includes a pair of lateral knuckle portions 70.1, 70.2 and a third medial knuckle portion 70.3 extending from the second lateral edge 52 of the shoe body 42. Second bearing block recesses 72.1, 72.2 are formed between the pair of lateral knuckle portions 70.1, 70.2 and the third medial knuckle portion 70.3, respectively. In this configuration, the first medial knuckle portion 66.1 of a first track shoe is received in the second bearing block recess 72.1 of a second track shoe, and the second medial knuckle portion 66.2 is received in the second bearing block recess 72.2 for interlinking adjacent first and second track shoes. One skilled in the art should understand that the number and spacing of the knuckle portions for the first and second bearing blocks may be different than as shown and described, provided they are complementary in design for interlinking adjacent track shows as explained above.

The shoe body 42, the first bearing block 44, the second bearing block 50 and the center guide 62 form a monolithic composite track shoe. In this context, these elements or features (e.g., shoe body, bearing blocks and center guide) of a monolithic track shoe are formed as a single, integral component. In an embodiment, the monolithic composite track shoe is constructed for a polymeric material, for example a monolithic acetal copolymer.

The shoe assembly 36 also include a track pad 74 detachably secured to the track shoe 40 and extending from a second face 76 of the shoe body 42 opposite the first face 64. The track pad 74 includes a pair of threaded studs 78 extending upwardly from a pad bed 80 and a pad sole 82 extending from the pad bed 80 opposite the threaded studs 78. A pocket 84 is formed in the second face 76 of the shoe body 42 and is configured to receive an upper portion of the track pad 74 when it is detachably secured to the track shoe 40. Bores 86 are formed through the shoe body 42 and each bore 86 receive a grommet 88. Each of the threaded studs 78 is inserted through a grommet 88 and receive a washer 90 and a nut 92 to detachably secure the track pad 74 to the shoe body 42.

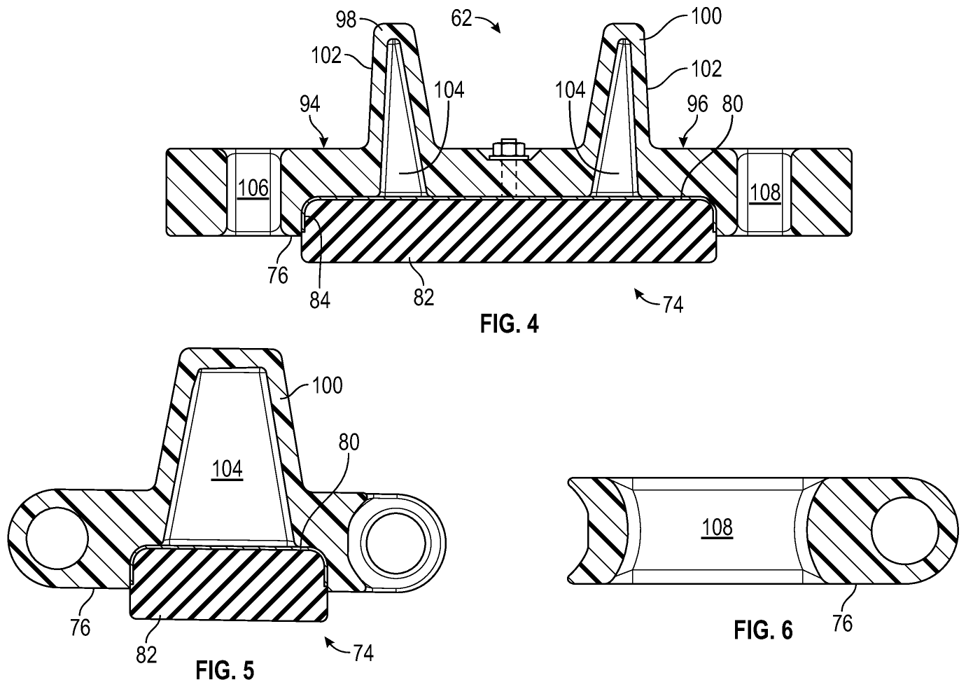

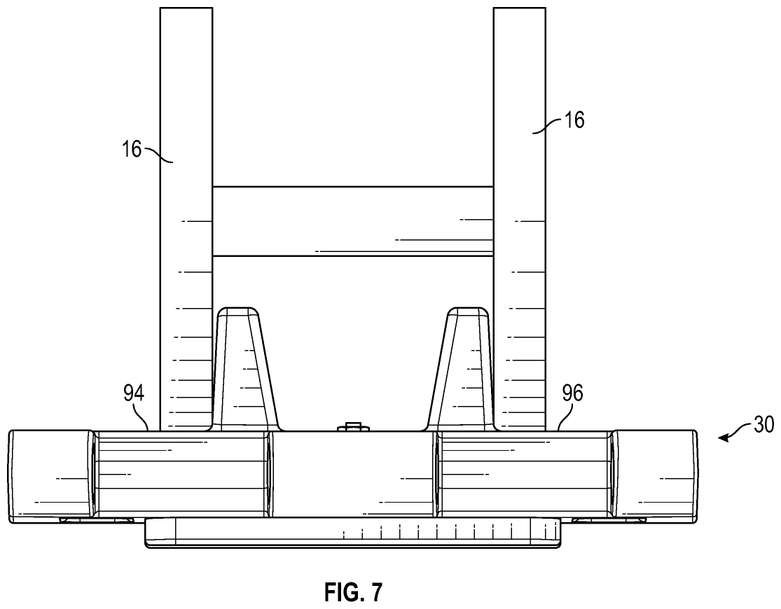

With reference now to FIGS. 2-7, the first face 64 of the shoe body 42 has a first race 94 and a second race 96 laterally spaced from the first race 94. The center guide 62 extends from the shoe body 42 between the first and second races 94, 96. Specifically, the center guide 62 includes first and second guide members 98, 100 arranged in spaced relationship and extending from upwardly from the first face 64. In an embodiment, each of the first and second guide members 98, 100 form a truncated pyramid having an outer side margin 102 that is generally perpendicular to the first face 64 and cooperate with the road wheels 16 for keeping the track 30 aligned on the suspension assembly 14. As seen in FIGS. 4 and 5, an interior region 104 of the first and second guide members 98, 100 may be formed with a void therein.

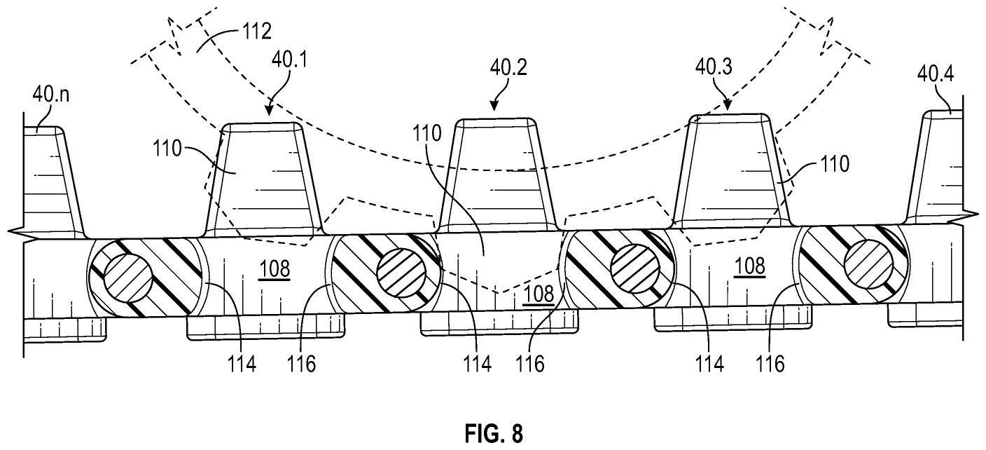

With reference to FIGS. 2-6 and 8, the shoe body 42 has a first pocket 106 laterally offset from the first race 94 and a second pocket 108 laterally offset from the second race 96. The first and second pockets 106, 108 extend through the shoe body 42 from the first face 64 to the second face 76. As best shown in FIG. 8, the pockets 106, 108 are configured to engage and receive sprocket teeth 110 extending from a sprocket wheel 112 (shown in broken line). For example, the sprocket wheel 112 may form a part of the drive wheel 26 or the idler wheel 28. The leading and trailing faces 114, 116 of each pocket 106, 108 are formed as arcuate camming surfaces for smoothly engaging and disengaging with the sprocket teeth 110 as the endless track 30 rotates around the sprocket wheel 112.

A plurality of shoe assemblies 36 as described above may arranged in laterally spaced adjacent relationship and operably coupled together to form the endless track 30. A portion of the endless track 30 is illustrated in FIG. 8 and includes a plurality of track shoes 40.1-40.n arranged the lateral edges 46, 52 of adjacent shoes. A pin assembly 38.1, 38.2, 38.3 associated with each track shoe 40.1, 40.2, 40.3 operably couples to one track shoe with an adjacent track shoe. For example, pin assembly 38.1 operable couples track shoe 40.1 with track shoe 40.2, and pin assembly 38.2 operably couples track shoe 40.2 with track shoe 40.3. The nth track shoe 40.n is operably coupled to the first track show 40.1 to form the endless track 30. As illustrated in FIG. 1, the endless track 30 includes seventy shoe assemblies 36 interconnected to form an endless track. One skilled in the art should appreciate that the number of track shoes used to form the endless track may vary based on the size and specifications of vehicle 10, suspension assembly 14 and shoe assemblies 36.

Spatially relative terms, such as “inner,” “outer,” “beneath,” “below,” “lower,” “above,” “upper,” and the like, may be used herein for ease of description to describe the relationship of one element or feature to another element or feature as illustrated in the figures. Spatially relative terms may be intended to encompass different orientations of the device in use or operation in addition to the orientation depicted in the figures. For example, if the components illustrated in the figures were turned over, elements or features described as “below”, or “beneath” other elements or features would then be oriented “above” or “on top of” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A shoe assembly for an endless track on a tracked vehicle comprising:
a composite track shoe having a shoe body, a first bearing block with a medial knuckle extending from a first lateral edge of the shoe body, a second bearing block with a pair of lateral knuckles extending from a second lateral edge of the shoe body opposite the first lateral edge and a second bearing block recess formed therebetween, and a center guide extending from a first face of the shoe body;
a track pad detachably secured to the track shoe and extending from a second face of the shoe body opposite the first face; and
a pin extending through the first bearing block;
wherein the medial knuckle is configured to be received in the second bearing block recess of an adjacent track shoe and the pin is configured to extend through the second bearing block of the adjacent track shoe.

2. The shoe assembly according to claim 1, wherein the composite track shoe including the shoe body, the first bearing block, the second bearing block and the center guide is a monolithic acetal copolymer track shoe.

3. The shoe assembly according to claim 1, wherein the first bearing block includes a first knuckle portion, a second knuckle portion and a first bearing block recess formed therebetween, and the second bearing portion includes a third knuckle portion formed between the pair of lateral knuckles and configured to be received in the first bearing block recess of the adjacent track shoe.

4. The shoe assembly according to claim 1, wherein the second face of the shoe body has a pocket formed therein and the track pad is disposed in the pocket.

5. The shoe assembly according to claim 1, wherein the shoe body comprises a first race and a second race laterally spaced from the first race, wherein the center guide extends from the shoe body between the first and second races.

6. The shoe assembly according to claim 5, where the center guide comprises first and second guide members extending from upwardly from the first face, wherein the first guide member is arranged in spaced relation to the second guide member.

7. The shoe assembly according to claim 6, wherein each of the first and second guide members form a truncated pyramid.

8. The shoe assembly according to claim 7, wherein an outer side margin the truncated pyramid is generally perpendicular to the first face.

9. The shoe assembly according to claim 7, wherein an interior region of the truncated pyramid has a void formed therein.

10. The shoe assembly according to claim 5, wherein the shoe body has a first pocket laterally offset from the first race and a second pocket laterally offset from the second race, wherein the first and second pockets extend through the shoe body from the first face to the second face.

11. An endless track for a tracked vehicle comprising:
a plurality of composite track shoes arranged in laterally spaced adjacent relationship and operably coupled together, each of the plurality of composite track shoes having a shoe body, a first bearing block with a medial knuckle extending from a first lateral edge of the shoe body, a second bearing block with a pair of lateral knuckles extending from a second lateral edge of the shoe body opposite the first lateral edge and a second bearing block recess formed therebetween, and a center guide extending from a first face of the shoe body, wherein the medial knuckle on a first track shoe is received in the second bearing block recess between the pair of lateral knuckles of a second track shoe adjacent the first track shoe;
a track pad detachably secured to the track shoe and extending from a second face of the shoe body opposite the first face; and
a pin extending through the first bearing block of the first track show and through the second bearing block of the second track shoe for pivotally coupling the first and second track shoes together.

12. The endless track according to claim 11, wherein the composite track shoe including the shoe body, the first bearing block, the second bearing block and the center guide is a monolithic acetal copolymer track shoe.

13. The endless track according to claim 12, wherein the first bearing block includes a first knuckle portion, a second knuckle portion and a first bearing recess formed therebetween, and the second bearing portion includes a third knuckle portion formed between the pair of lateral knuckles and configured to be received in the first bearing recess of the adjacent track shoe.

14. The endless track according to claim 11, wherein the second face of the shoe body has a pocket formed therein and the track pad is disposed in the pocket.

15. The endless track according to claim 11, wherein the shoe body comprises a first race and a second race laterally spaced from the first race, wherein the center guide extends from the shoe body between the first and second races.

16. The endless track according to claim 15, where the center guide comprises first and second guide members extending from upwardly from the first face, wherein the first guide member is arranged in spaced relation to the second guide member.

17. The endless track according to claim 16, wherein each of the first and second guide members form a truncated pyramid.

18. The endless track according to claim 17, wherein an outer side margin the truncated pyramid is generally perpendicular to the first face.

19. The endless track according to claim 17, wherein an interior region of the truncated pyramid has a void formed therein.

20. The endless track according to claim 15, wherein the shoe body has a first pocket laterally offset from the first race and a second pocket cutout laterally offset from the second race, wherein the first and second pockets extend through the shoe body from the first face to the second face.
